(19) United States
(12) Patent Application Publication
(10) Pub. No.: US 2025/0010436 A1
(43) Pub. Date: Jan. 9, 2025

(54) Multimode Hand Tool

(71) Applicant: Klein Tools, Inc., Lincolnshire, IL (US)

(72) Inventors: Cameron Knauth, Mansfield, TX (US); Jordan L. Fisher, Arlington, TX (US); Austin Minor, Aledo, TX (US)

(73) Assignee: Klein Tools, Inc., Lincolnshire, IL (US)

(21) Appl. No.: 18/763,845

(22) Filed: Jul. 3, 2024

Related U.S. Application Data
(60) Provisional application No. 63/525,081, filed on Jul. 5, 2023.

(51) Int. Cl. B25B 21/00; B25B 13/46

(52) U.S. Cl. CPC B25B 21/007; B25B 13/463

(57) ABSTRACT

A multimode hand tool is disclosed for driving a threaded fastener component in three different modes. A first mode allows a handheld power drive, such as a handheld drill/driver, to rotate a threaded fastener via the hand tool similar to a conventional right angle drive attachment. A second mode allows a user to rotate a threaded fastener by applying a torque force onto a portion of the hand tool in the same fashion as when using a standard ratchet wrench. A third mode allows a user to rotate a threaded fastener by rotating one part of the hand tool relative to another part of the hand tool.

### CROSS-REFERENCE TO RELATED APPLICATIONS

This application claims priority to U.S. provisional application 63/525,081 filed Jul. 5, 2023, and titled Multimode Hand Tool, the entire disclosure of which is incorporated herein by reference.

### BACKGROUND OF THE DISCLOSURE

The present disclosure relates to ratchet wrenches and right angle drives. It is well known to provide a wrench having a ratchet mechanism that selectively transfers torque to a driven member from a handle of the wrench to allow a user to rotate/drive a threaded fastener. It is also known to provide an right angle adapter that can allow a hand held power driver, such as hand held powered drill/driver, to drive fastener at a perpendicular angle to the rotational axes of the chuck or quick connect to the powered drill/driver. While there are many conventional tools that provide such capabilities, there is always room for improvement, including combining such features into a single handheld tool.

### BRIEF SUMMARY OF THE DISCLOSURE

In accordance with one feature of this disclosure, a multimode hand tool is provided for driving a threaded fastener component in at least three different modes. The hand tool includes a drive head, a drive member, a shaft housing, a shaft, a handle, and a ratchet mechanism. The drive member is mounted in the drive head for rotation about a drive axis. The drive member has a through opening centered on the drive axis and configured to engage with an exterior drive surface of at least one of a threaded nut and a nut driving socket. The shaft housing extends from the drive head along a shaft axis. The shaft axis is non-parallel to the drive axis. The drive head is fixed to the shaft housing. The shaft is mounted in the shaft housing for rotation about the shaft axis and extends along the shaft axis from a driven end of the shaft to a drive end of the shaft. The driven end has an exterior surface configured for selective engagement with a handheld power drive to transfer torque from the power drive to the shaft. The drive end is operably connected to the drive member to transfer torque to the drive member. The handle extends along the shaft axis from a first end adjacent the drive head to a second end adjacent the driven end of the shaft. The shaft housing is mounted in the handle to translate along the shaft axis between first, second and third positions. The shaft is fixed in the shaft housing for translation therewith between the first, second and third positions. The ratchet mechanism is mounted adjacent the second end of the handle and the driven end of the shaft to selectively transmit a torque between the handle and the shaft. In the first position, the driven end of the shaft extends outwardly from the second end of the handle for selective engagement with a handheld power drive to transfer torque from the handheld power drive to the drive member. In the second position, the handle and the shaft housing are engaged to prevent relative rotation therebetween and the driven end of the shaft is engaged with the ratchet mechanism to transfer torque from the handle to the drive member as the drive head is rotated about the drive axis. In the third position, the driven end of the shaft is engaged with the ratchet mechanism to transfer torque from the handle to the drive member as the handle is rotated about the shaft axis relative to the shaft housing.

As one feature, the ratchet mechanism includes a ratchet housing fixed in the second end of the handle, a ratchet spline mounted in the ratchet housing for rotation about the shaft axis relative to the handle, and at least one pawl carried in the ratchet housing for transmitting a torque from the ratchet housing to the ratchet spline.

In one feature, the ratchet mechanism is configured to selectively transfer torque in first and second rotational directions, and the ratchet mechanism further includes a selector member mounted at the second end of the handle for rotation about the shaft axis relative to the handle between a first rotational position that enables the ratchet mechanism to transfer torque in the first rotational direction and a second rotational position that enables the ratchet mechanism to transfer torque in the second rotational direction.

According to one feature, the driven end of the shaft is engaged with the spline for rotation of the shaft therewith with the shaft housing in the second and third positions; and the driven end of the shaft is disengaged from the spline and the shaft rotates relative to the spline with the shaft housing in the first position.

As one feature, the drive head and the shaft housing are a unitary component formed from a single piece of material.

According to one feature, the multimode hand tool further includes: a driven bevel gear fixed to the drive member for rotation therewith about the drive axis; and a drive bevel gear fixed to the drive end of the shaft for rotation therewith about the shaft axis, the bevel gears engaged with each other to transmit torque from the shaft to the drive member. In a further feature, the driven bevel gear and the drive member are a unitary component formed from a single piece of material; and the drive bevel gear and the shaft are a unitary component formed from a single piece of material.

In one feature, the drive axis and the shaft axis are perpendicular to each other.

As one feature, the driven end of the shaft has a hexagonal shaped transverse cross-section; and the shaft further includes a cylindrical shaped portion extending from the driven end toward the drive end, the cylindrical shaped portion extending through the ratchet mechanism with the shaft housing in the first position.

In one feature, one of the handle and the shaft housing includes a detent mechanism that is releasably engaged with a detent receiving relief on the other of the handle and the shaft housing in each of the first, second and third positions. In a further feature, the handle includes the detent mechanism and at least one bearing surface mounting the shaft housing for rotation and translation relative to the handle.

In accordance with one feature of this disclosure, a multimode hand tool is provided for driving a threaded fastener component in at least two different modes. The hand tool includes a drive head, a drive member, a shaft housing, a shaft, a handle, and a ratchet mechanism. The drive member is mounted in the drive head for rotation about a drive axis. The drive member has a through opening centered on the drive axis and configured to engage with an exterior drive surface of at least one of a threaded nut and a nut driving socket. The shaft housing extends from the drive head along a shaft axis. The shaft axis is non-parallel to the drive axis. The drive head is fixed to the shaft housing. The shaft is mounted in the shaft housing for rotation about the shaft axis and extends along the shaft axis from a driven end of the shaft to a drive end of the shaft. The driven end has an exterior surface configured for selective engagement with a handheld power drive to transfer torque from the power drive to the shaft. The drive end is operably connected to the drive member to transfer torque to the drive member. The handle extends along the shaft axis from a first end adjacent the drive head to a second end adjacent the driven end of the shaft. The shaft housing is mounted in the handle to translate along the shaft axis between first and second positions and the shaft is fixed in the shaft housing for translation therewith between the first and second positions. The ratchet mechanism is mounted in the hand tool to selectively transmit a torque between the handle and the shaft. In the first position, the driven end of the shaft extends outwardly from the second end of the handle for selective engagement with a handheld power drive to transfer torque from the handheld power drive to the drive member. In the second position, the handle and the shaft housing are engaged to prevent relative rotation therebetween and the driven end of the shaft is engaged with the ratchet mechanism to transfer torque from the handle to the drive member as the drive head is rotated about the drive axis.

In one feature, the ratchet is mounted in the drive head.

As one feature, the ratchet is mounted adjacent the second end of the handle.

According to one feature, the shaft housing is mounted in the handle to translate along the shaft axis to a third position; and in the third position the shaft is engaged with the ratchet mechanism to transfer torque from the handle to the drive member as the handle is rotated about the shaft axis relative to the shaft housing.

### BRIEF SUMMARY OF THE SEVERAL VIEWS OF THE DRAWINGS

FIG. 1 is a perspective view from below and to the left of a multimode hand tool according to this disclosure;

FIG. 2 is a perspective view from above and to the right of the tool of FIG. 1;

FIG. 3 is a top plan view of the tool of FIGS. 1-2;

FIG. 4 is a right side elevation view of the tool of FIGS. 1-3;

FIG. 5 is a bottom view of the tool of FIGS. 1-4;

FIG. 6 is a section view of the tool of FIGS. 1-5 taken from line 6-6 in FIG. 4 and showing the tool in a first mode;

FIG. 7 is a view identical to FIG. 6 but showing the tool in a second mode;

FIG. 8 is a view identical to FIG. 6 but showing the tool in a third mode;

FIG. 9 is a top view showing selected components of the tool of FIGS. 1-8;

FIG. 10 is an enlarged section view of the tool of FIGS. 1-9 taken from line 10-10 in FIG. 4;

FIG. 11 is an enlarged, perspective, section view of a portion of the tool of FIGS. 1-10;

FIG. 12 is an enlarged, exploded perspective view of selected components of the of FIGS. 1-11;

FIG. 13A is a section view similar to that of FIG. 6, but showing another embodiment of a multimode hand tool according to this disclosure in a first mode; and

FIG. 13B is a section view identical to FIG. 13A but showing the tool in a second mode.

### DETAILED DESCRIPTION OF PREFERRED EMBODIMENTS

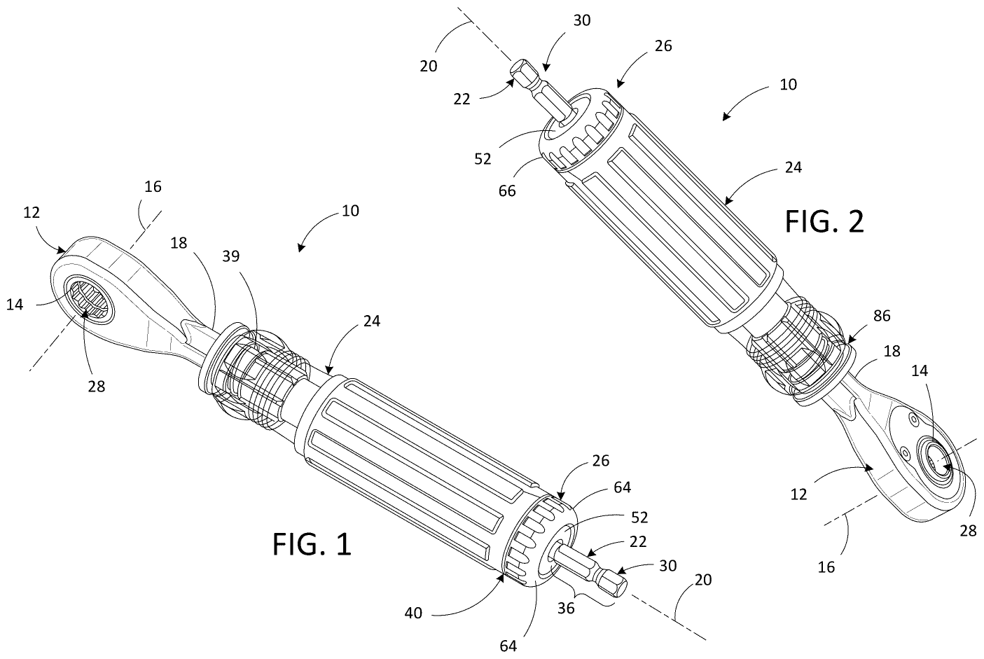

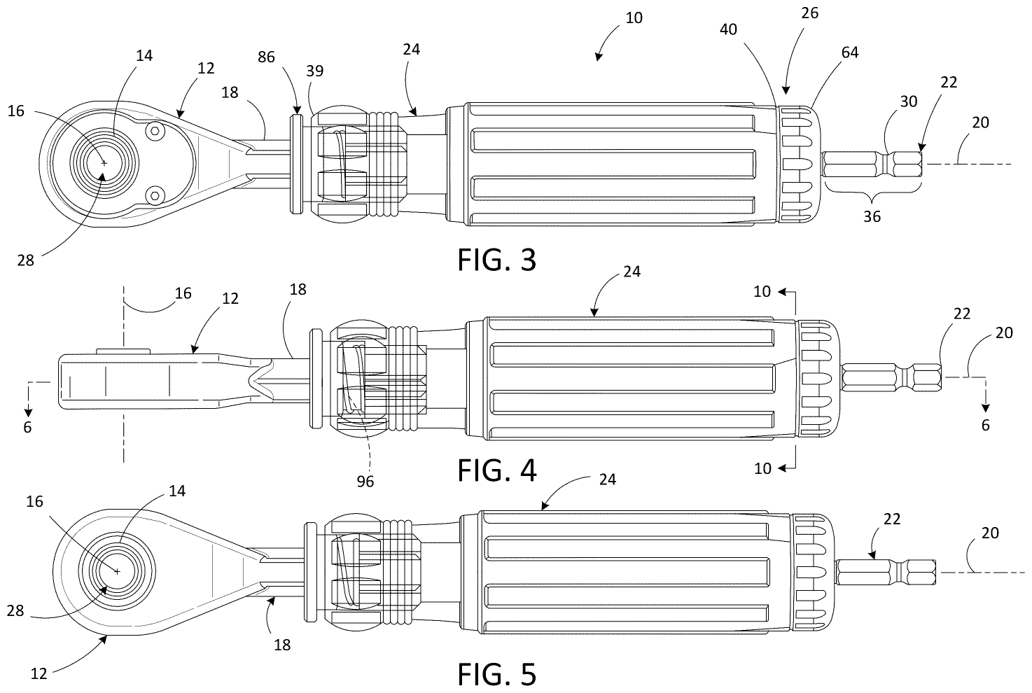

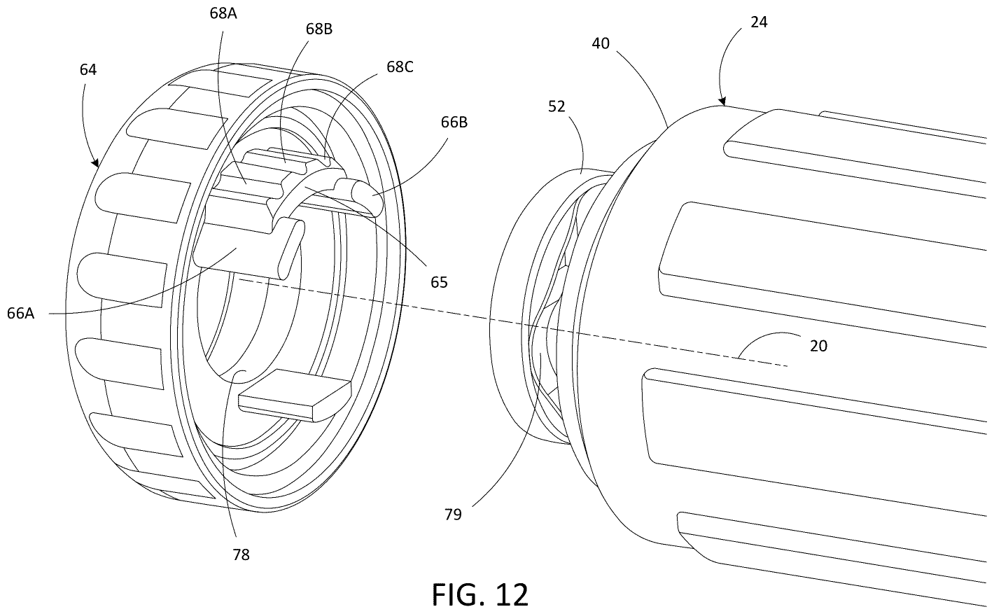

As best seen in FIGS. 1-12, in the illustrated embodiment, a multimode hand tool 10 is provided for driving a threaded fastener component (such as a threaded nut, a threaded screw, or a threaded bolt) in three different modes. A first mode allows a handheld power drive, such as a handheld drill/driver, to rotate a threaded fastener via the hand tool 10 similar to a conventional right angle drive attachment. A second mode allows a user to rotate a threaded fastener by apply a torque force onto a portion of the hand tool 10 in the same fashion as when using a standard ratchet wrench. A third mode allows a user to rotate a threaded fastener by rotating one part of the hand tool relative to another part of the hand tool.

The hand tool 10 embodiment shown in FIGS. 1-8 includes a drive head 12, a drive member 14 mounted in the drive head 12 for rotation about a drive axis 16, a shaft housing 18 extending from the drive head 12 along a shaft axis 20 that is perpendicular to the drive axis 16, a shaft 22 mounted in the shaft housing 18 for rotation about the shaft axis 20 relative to the shaft housing 18, a handle 24 extending along the shaft axis 20, and a ratchet mechanism 26. The drive member 14 has a through opening 28 that is centered on the drive axis 16 and configured to engage with an exterior drive surface of at least one of a threaded nut, a nut driving socket, or the head of a screw or bolt.

In the illustrated and preferred embodiment, the drive head 12 and the shaft housing 18 are a unitary component formed from a single piece of material, such as being machined from a single piece of steel or other suitable metal. However, it should be understood that in some embodiments it may be advantageous for the drive head 12 and shaft housing 18 to be formed as separate components that are then assembled together. Similarly, it should be understood that while the drive axis 16 and shaft axis 20 are shown as being perpendicular to each other, in some embodiments it may be desirable for axes 12 and 20 to extend at a different, non-parallel angle to each other somewhere between the range of 0 degrees to 180 degrees.

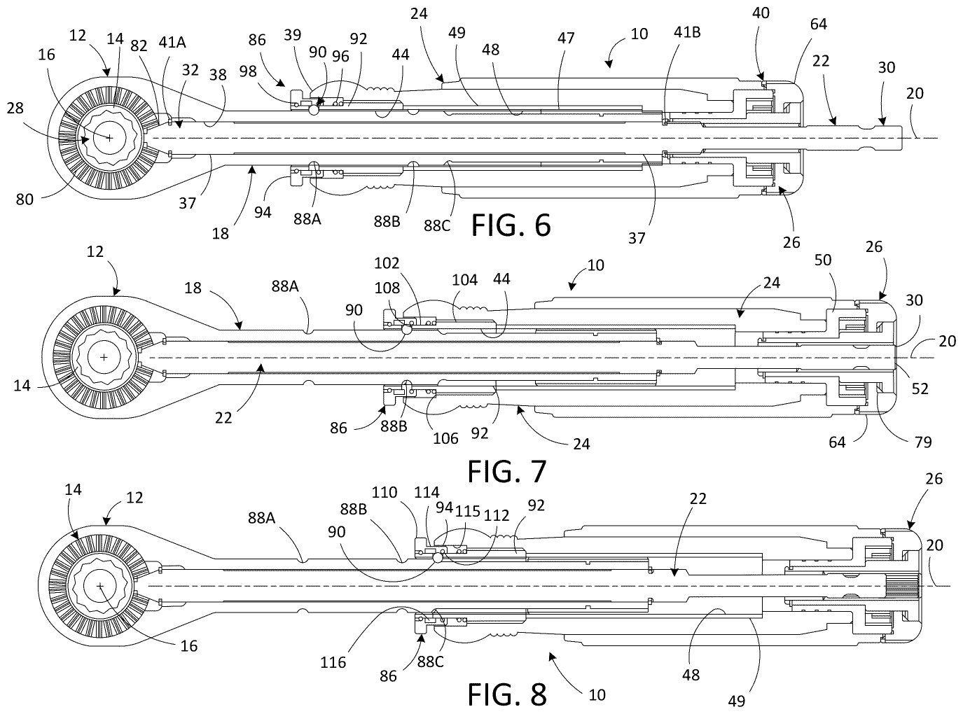

As best seen in FIG. 6, the shaft 22 extends along the shaft axis 20 from a driven end 30 of the shaft 22 to a drive end 32 of the shaft 22. As best seen in FIGS. 1 and 2, the driven end 30 has an exterior surface 36 configured for selective engagement with a handheld power drive, such as to a quick connect or chuck of the power drive, to transfer torque from the power drive to the shaft 22. In this regard the driven end 30 of the illustrated embodiment has a hexagonal shaped cross-section of a standard size, such as ¼ inch or 5/16 inch and includes an annular, concave groove configured to receive a ball detent of a quick connect connection of a powered driver, which is a well-known and standard configuration. The drive end 32 is operably connected to the drive member 14 to transfer torque to and from the drive member 14. The shaft 22 includes a spaced pair of cylindrical surfaces 37 that are received in a through bore 38 formed in shaft housing 18 to mount the shaft 22 for rotation about the shaft axis 20 relative to the shaft housing 18. The handle 24 extends along the shaft axis 20 from a first end 39 adjacent the drive head 12 to a second end 40 adjacent the driven end 30 of the shaft 22. In the illustrated and preferred embodiment, the ratchet mechanism 26 is mounted adjacent the second end 40 of the handle 24 and the driven end 30 of the shaft 22 to selectively transmit a torque to and from the handle 24 and the shaft 22.

As best seen in FIGS. 6-8, the shaft housing 18 is mounted in the handle 24 to translate along the shaft axis 20 between a first position (shown in FIGS. 1-6), a second position (shown in FIG. 7) and a third position (shown in FIG. 8), with the first position providing the first mode, the second position providing the second mode, and the third position providing the third mode. The shaft 22 is retained in the shaft housing 18 for translation therewith between the first, second and third positions by a pair of retaining rings 41A and 41B attached to the opposite ends of the shaft 22. In the first position, the driven end 30 of the shaft 20 extends outwardly from the second end 40 of the handle 24 for selective engagement with a handheld power drive, such as a drill/driver, to transfer torque from the handheld power drive to the drive member 14, with the ratchet mechanism being disengaged from the shaft 22. In the second position, the handle 24 and the shaft housing 18 are engaged to prevent relative rotation therebetween and the driven end 30 of the shaft 22 is engaged with the ratchet mechanism 26 to transfer torque from the handle 24 to the drive member 14 as the drive head 12 is rotated about the drive axis 16 in a fashion like that of a standard ratchet wrench. In the third position, the driven end 30 of the shaft 22 is engaged with the ratchet mechanism 26 to transfer torque from the handle 24 to the drive member 14 as the handle 24 is rotated about the shaft axis 20 relative to the shaft housing 18 and the drive head 12.

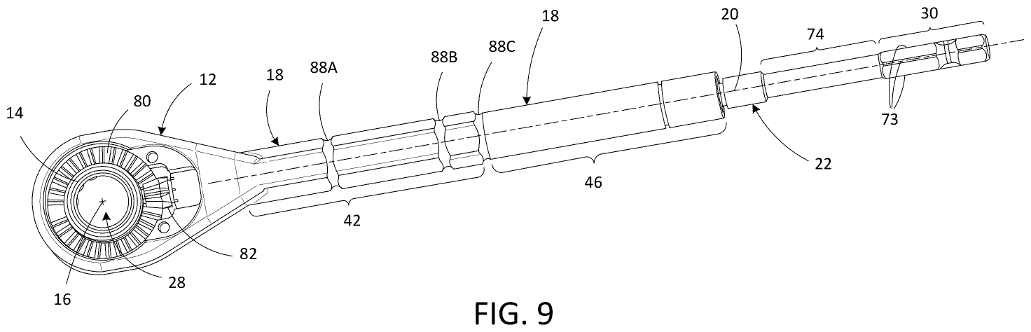

As best seen in FIG. 9, a portion 42 of the shaft housing 18 had a hexagonal shaped transverse cross-section extending over a length of the shaft axis 20 adjacent the drive head 12 for sliding engagement with a through passage 44 in the handle 12, with the passage 44 also having a hexagonal shaped transverse cross-section to prevent rotation of the shaft housing 18 relative to the handle 24 about the shaft axis 20 with the shaft housing 18 in the first and second positions shown in FIGS. 6 and 7, respectively. It should be understood that while the hexagonal shaped cross-sections are preferred, in some embodiments it may be advantageous to use other suitably shaped cross sections that will prevent relative rotation between the shaft housing 18 and the handle 24, such as, for example, other polygonal shaped cross-sections or sliding spline teeth. Another portion 46 of the shaft housing 18 has a cylindrical shape extending over a length of the shaft housing 18 adjacent the hexagonal portion 42, with portion 46 having an outside diameter that is smaller than the projected diameter of the hexagonal portion 42. The portion 46 is located so that it extends through the through passage 44 of the handle 24 and the portion 42 is located outside of the passage 44 with the shaft housing 18 in the third position shown in FIG. 8 to allow the handle 24 to rotate about the shaft axis 20 relative to the shaft housing 18. In the illustrated embodiment, a bearing component having a cylindrical outermost surface 47 is carried on a part of the cylindrical portion 46 and has a rotating fit with a cylindrical bore 48 in the handle 24 to provide rotational support of the handle 24 relative to shaft housing 18 with the shaft housing 18 in the third position and to provide translational support as the shaft housing 18 is translated between the first, second, and third positions. In the illustrated embodiment, the cylindrical bore 48 is defined by a cylindrical sleeve 49 that is fixed in a remainder of the handle 24, such as by an interference fit or by being molded in place, with the sleeve being made of any suitable material for sliding and rotational support.

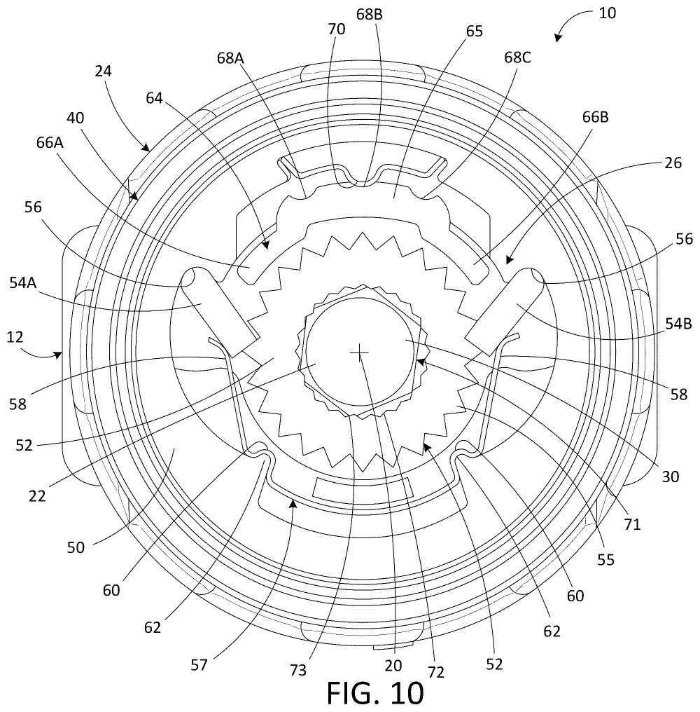

As best seen in FIG. 10-12, in the illustrated embodiment, the ratchet mechanism 26 includes a ratchet housing 50 fixed in the second end 40 of the handle 24, a ratchet spline 52 mounted in the ratchet housing 50 for rotation about the shaft axis 20 relative to the handle 24, and two pawls 54A and 54B (best seen in FIG. 9) carried in the ratchet housing 50 for transmitting a torque from the ratchet housing 50 to the ratchet spline 52 via engagement with longitudinally extending spline teeth 55 on the ratchet spline 52 and concave pawl receptacles 56 on the housing 50. As best seen in FIG. 9, a u-shaped leaf spring 57 has a pair of spring legs 58, with each leg 58 engaged with a corresponding one of the pawls 54 to bias the pawl 54 into engagement with the spline 52. The leaf spring 56 includes a pair of shaped concave reliefs 60 that engage corresponding convex lugs 62 on the ratchet housing 50 to prevent rotation of the leaf spring 56 relative to the housing 50 and to positively locate the leaf spring 56 within the ratchet mechanism 26.

In the illustrated embodiment, the ratchet mechanism 26 is configured to selectively transfer torque in first and second rotational directions about the shaft axis 20 using a selector member 64 mounted at the second end 40 of the handle 24 for selective rotation about the shaft axis 20 relative to the handle 24 and ratchet housing 50 between a first rotational position that enables the ratchet mechanism 26 to transfer torque in the first rotational direction, a second rotational position that enables the ratchet mechanism 26 to transfer torque in the second rotational direction and a neutral rotational position (shown in FIG. 10) that enable the ratchet mechanism to transfer torque in both the first and the second rotational directions. In this regard, the selector member includes an axially extending tongue 65 that defines a pair of oppositely directed arms 66A and 66 B, and three concave detent reliefs 68A-C that are configured to selectively engage a convex detent bump 70 extending from the ratchet housing 50. With reference to FIG. 10, the selector member 64 is shown in a neutral, center position with the detent bump 70 engaged in the center detent relief 68B and both of the arms 66 positioned so that they do not engage either of the pawls 54. In this condition, the ratchet mechanism 26 transfers torque to and from the handle 24 and the ratchet spline 52 in both the clockwise and counterclockwise direction, thereby preventing relative rotation between the handle 24 and the ratchet spline 52. When the selector member 64 is rotated in the clockwise direction of FIG. 10, the detent bump 70 will engage the detent relief 68A and the arm 66B will engage the pawl 54B and prevent the pawl 54B from engaging the ratchet spline 52. This places the ratchet mechanism 26 in a condition where it will transfer torque in the counterclockwise direction from the handle 24 to the ratchet spline 52 while allowing the handle 24 to rotate in the clockwise direction relative to the ratchet spline 52. It follows that, in this same condition, the ratchet mechanism 26 will transfer torque in the clockwise direction from the ratchet spline to the handle 24 while allowing the ratchet spline to rotate in the counterclockwise direction relative to the handle 24. When the selector member 64 is rotated in the counterclockwise direction of FIG. 10, the detent bump 70 will engage the detent relief 68C and the arm 66A will engage the pawl 54A and prevent the pawl 54A from engaging the ratchet spline 52. This places the ratchet mechanism 26 in a condition where it will transfer torque in the clockwise direction from the handle 24 to the ratchet spline 52 while allowing the handle 24 to rotate in the counterclockwise direction relative to the ratchet spline 52. If follows that, in the same condition, the ratchet mechanism 26 will transfer torque in the counterclockwise direction from the ratchet spline 52 to the handle 24 while allowing the ratchet spline 52 to rotate in the clockwise direction relative to the handle 24.

The ratchet spline 54 includes a through passage 71 that is configured to engage the driven end 30 of the shaft 22 for rotation of the shaft 22 with the spline 52 about the axis 20 with the shaft housing 18 in the second and third positions. In this regard, in the illustrated embodiment, the through passage 71 is configured with spline teeth 72 that extend parallel to the shaft axis 20 and engage the edges/points 73 of the hexagonal shaped transverse cross-section of the driven end 30 of the shaft 22 to prevent relative rotation between the ratchet spline 52 and the shaft 22 with the shaft housing 18 in the second and third positions. The driven end 30 of the shaft 22 is disengaged from the through passage 70 of the ratchet spline 54 to allow the shaft 22 to rotate relative to the spline 52 with the shaft housing 18 in the first position best seen in FIG. 6. In this regard, in the illustrated embodiment, the shaft 22 has a cylindrically shaped portion 74 that extends over a length of the shaft 22 adjacent the drive end 30 and that extends through the passage 71 with the shaft housing 18 in the first position. The outer diameter of the cylindrically shaped portion 74 is less than the radially innermost tooth diameter of the spline teeth 72 so that the portion 74 does not engage the spline teeth 72, thereby allowing the shaft 22 to rotate relative to the ratchet spline 52 with the shaft housing 18 in the first position.

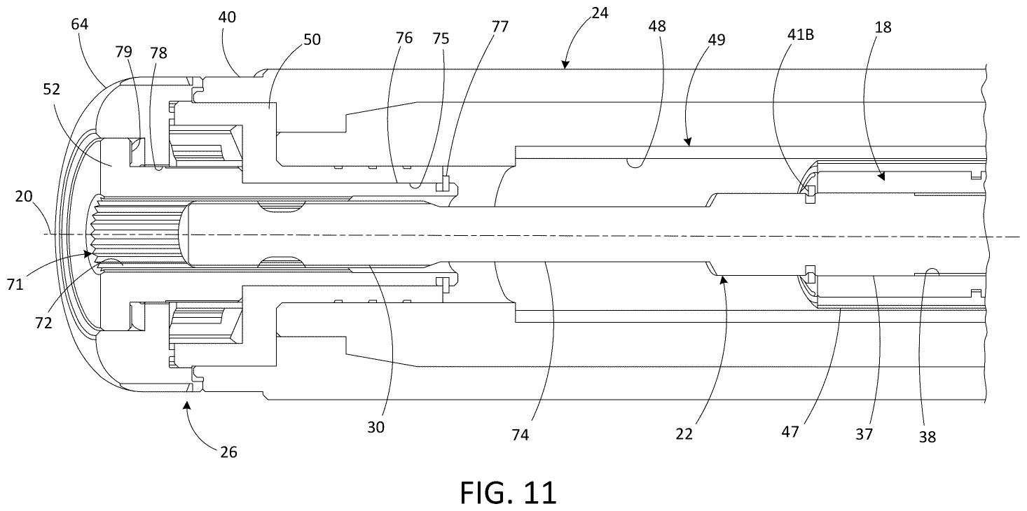

As best seen in FIG. 11, the ratchet housing 50 has a through bore 75 that receives a cylindrical outer surface 76 of the ratchet spline 52 to support the ratchet splint 52 for rotation about the shaft axis 20 relative to the ratchet housing 50. A retaining ring 77 is engaged with the ratchet spline 52 to retain the ratchet spline 52 in the ratchet housing 50. The selector member 64 has a through bore 78 through which the ratchet spline 52 extends. A wave spring 79 is sandwiched between the selector member 64 and the ratchet spline 52 to provide an assembly force that is reacted through the ratchet mechanism 26 and that allows the relative rotations of the various ratchet components while maintaining their axial engagements.

It should be understood that while one preferred configuration is illustrated for the ratchet mechanism 26, there are many known ratchet configurations, constructions, and arrangements that could be satisfactorily used in the device 10. Accordingly, no limitation to a specific ratchet configuration/construction/arrangement is intended unless specifically recited in a claim appended hereto.

As best seen in FIG. 6, in the illustrated embodiment, the hand tool 100 further includes a driven gear 80 fixed to the drive member 14 for rotation therewith about the drive axis 16, and a drive gear 82 fixed to the drive end 32 of the shaft 22 for rotation therewith about the shaft axis 20, with the gears 80 and 82 being engaged with each other to transmit torque from the shaft 22 to the drive member 14 and from the drive member 14 to the shaft 22. In the illustrated and preferred embodiment, the gears 80 and 82 are mating bevel gears, but it should be understood that in some embodiment other types of gears may be advantageous. In the illustrated and preferred embodiment, the driven gear 80 and the drive member 14 are a unitary component formed from a single piece of material, and the drive gear 82 and the shaft 22 are a unitary component formed from a single piece of material. However, it should be understood that in some embodiments, it may be advantageous for the driven gear 80 and drive member 14 to be formed from separate components that are then fixed together for rotation, and/or for the drive gear 82 and the drive shaft 22 to be formed from separate components that are then fixed together for rotation.

As best seen in FIGS. 6-8, the handle 24 includes a detent mechanism 86 that releasably engages with detent receiving, annular grooves 88A, 88B, and 88C on the shaft housing 18 in each of the first, second and third positions, respectively, to locate and retain the shaft housing in each of the first, second and third positions. In the illustrated embodiment, the detent mechanism 86 includes a plurality (preferably three) of ball bearings 90, a generally cylindrical shaped bearing guide 92 fixed in a remainder of the handle 24, a cylindrical shaped user actuation component 94 mounted to translate along the shaft axis 22 relative to the bearing guide 92 between a lock position and an actuating position, a helical compression spring 96 engaged between the bearing guide and the actuation component to bias the actuation component to the lock position, and a retaining ring 98 fixed on the bearing guide 92 to limit axial translation of the actuation component 94 relative to the bearing guide 92. As best seen in FIG. 7, The bearing guide 92 includes the through passage 44, an first outer surface 102, a second outer surface 104, an annular shoulder 106 facing the first end 39, and a plurality of radial through openings 108, with each of the openings 108 receiving one of the ball bearings 90. As previously discussed, the through passage 44 is sized to allow the shaft housing 18 to translate along the shaft axis 20 relative to the handle 24. The cylindrical surface 104 is sized for an interference fit with a bore in a remainder of the handle 24 to prevent movement of the bearing guide 92 relative to the remainder of the handle 24. As best seen in FIG. 8, the actuation component 94 includes an annular rib 110 for engagement by a users fingers, a through passage 112 that conforms to and has a sliding fit with the first outer surface 102 to allow translation of the component 94 along the shaft axis 20 relative to the bearing guide 92, an outer surface 114 that conforms to and has a sliding fit with an opening 115 in the remainder of the handle 24 to allow translation of the component 94 along the shaft axis 20 relative to the remainder of the handle 24, and an annular relief or groove 116 that selectively receives the ball bearings 90 when the component 94 is moved to an actuating position which allows the bearing 90 to be radially displaced from each of the detent receiving grooves 88A-C to free the shaft housing 18 for translation along the shaft axis 20 relative to the handle 24

It should be appreciated that while a preferred configuration is shown for the detent mechanism 86, other configurations may be utilized in the tool 10. Furthermore is should be understood that structure other than a detent mechanism could be used to selectively retain the shaft housing 18 in each of the first, second and third positions. Additionally, it should be appreciated that while the detent mechanism is shown as being carried in the handle 24, in some embodiments it may be desirable for the detent mechanism to be carried on the shaft housing 18 and for the grooves similar to the grooves 88A-C to be provided in the handle 24.

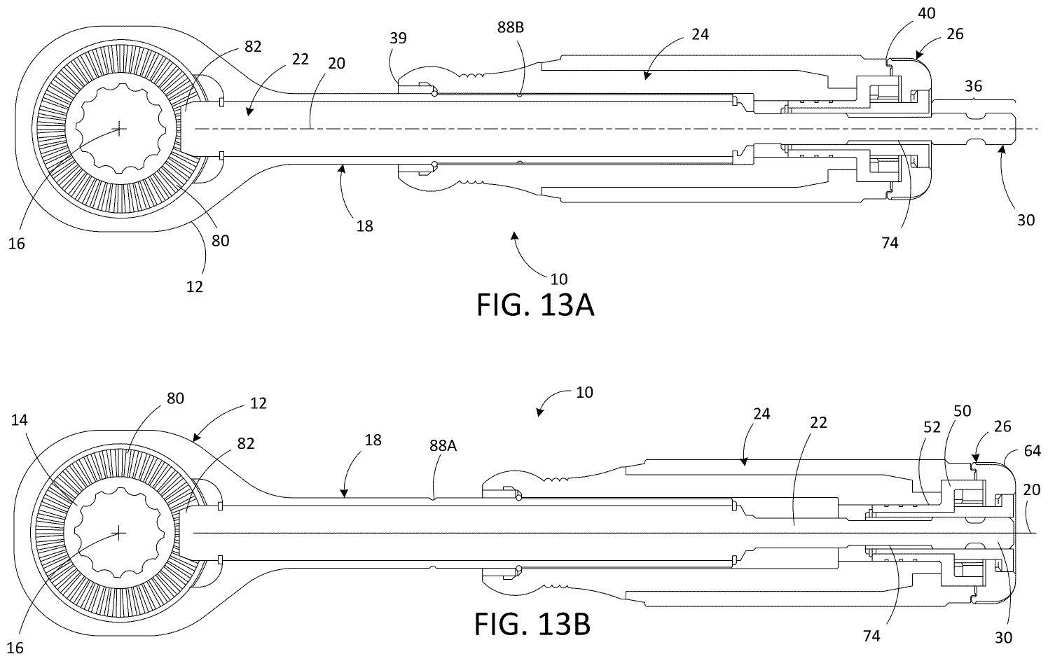

It should be appreciated that while the embodiment of the multimode tool 100 shown in FIGS. 1-12 is preferred, other embodiments are possible. For example, FIGS. 13A and 13B, show an alternate embodiment of the tool 100 having only the first and second modes. FIG. 13A shows the tool 100 in the first mode that allows a handheld power drive, such as a handheld drill/driver, to rotate a threaded fastener via the hand tool 10 similar to a conventional right angle drive attachment. FIG. 13B shows the tool 100 in the second mode that allows a user to rotate a threaded fastener by apply a torque force onto a portion of the hand tool 10 in the same fashion as when using a standard ratchet wrench. The third mode provided by the embodiment of the tool 100 shown in FIGS. 1-12 isn't provide and the elimination of the third mode allows for the embodiment of the tool 100 shown in FIGS. 13A-B to be a more compact and simpler design than the embodiment of FIGS. 1-12. More specifically, the cylindrical portion 46, the detent receiving groove 88C, and the bearing component/surface 47 of the FIGS. 1-12 embodiment have been eliminated from the embodiment shown in FIGS. 13A-B, and the end portion 30 of the shaft 22 of the FIGS. 13A-B embodiment is shorter than that of the FIGS. 1-12 embodiment. As another example, while it is preferred that ratchet mechanism 26 be provided adjacent the second end 40 of the handle 24, in some embodiments if may be advantageous for the ratchet mechanism to be provide adjacent the first end 39 of the handle 24, such as in the head 12.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the multimode hand tool 100 are shown in the figures, it should be understood that this disclosure anticipates variations in the specific details of each of the disclosed components and features of the multimode hand tool 100 and that no limitation to a specific form, configuration, or detail is intended unless expressly and specifically recited in an appended claim.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

The following are examples of features that could be claimed based on this disclosure, but it should be understood that any combination of the disclosed features could be claimed:

1. A multimode hand tool for driving a threaded fastener component in at least three different modes, the hand tool comprising:
a drive head
a drive member mounted in the drive head for rotation about a drive axis, the drive member having a through opening centered on the drive axis and configured to engage with an exterior drive surface of at least one of a threaded nut and a nut driving socket;
a shaft housing extending from the drive head along a shaft axis, the shaft axis being non-parallel to the drive axis, the drive head fixed to the shaft housing;
a shaft mounted in the shaft housing for rotation about the shaft axis, the shaft extending along the shaft axis from a driven end of the shaft to a drive end of the shaft, the driven end having an exterior surface configured for selective engagement with a handheld power drive to transfer torque from the power drive to the shaft, the drive end operably connected to the drive member to transfer torque to the drive member;
a handle extending along the shaft axis from a first end adjacent the drive head to a second end adjacent the driven end of the shaft, the shaft housing mounted in the handle to translate along the shaft axis between first, second and third positions and the shaft fixed in the shaft housing for translation therewith between the first, second and third positions; and
a ratchet mechanism mounted adjacent the second end of the handle and the driven end of the shaft to selectively transmit a torque between the handle and the shaft;
wherein:
   in the first position the driven end of the shaft extends outwardly from the second end of the handle for selective engagement with a handheld power drive to transfer torque from the handheld power drive to the drive member,
   in the second position the handle and the shaft housing are engaged to prevent relative rotation therebetween and the driven end of the shaft is engaged with the ratchet mechanism to transfer torque from the handle to the drive member as the drive head is rotated about the drive axis; and
   in the third position the driven end of the shaft is engaged with the ratchet mechanism to transfer torque from the handle to the drive member as the handle is rotated about the shaft axis relative to the shaft housing.

2. The multimode hand tool of claim 1 wherein the ratchet mechanism comprises a ratchet housing fixed in the second end of the handle, a ratchet spline mounted in the ratchet housing for rotation about the shaft axis relative to the handle, and at least one pawl carried in the ratchet housing for transmitting a torque from the ratchet housing to the ratchet spline.

3. The multimode hand tool of claim 2 wherein the ratchet mechanism is configured to selectively transfer torque in first and second rotational directions, and wherein the ratchet mechanism further comprises a selector member mounted at the second end of the handle for rotation about the shaft axis relative to the handle between a first rotational position that enables the ratchet mechanism to transfer torque in the first rotational direction and a second rotational position that enables the ratchet mechanism to transfer torque in the second rotational direction.

4. The multimode hand tool of claim 2 wherein
the driven end of the shaft is engaged with the spline for rotation of the shaft therewith with the shaft housing in the second and third positions; and
the driven end of the shaft is disengaged from the spline and the shaft rotates relative to the spline with the shaft housing in the first position.

5. The multimode hand tool of claim 1 wherein the drive head and the shaft housing are a unitary component formed from a single piece of material.

6. The multimode hand tool of claim 1 further comprising:
a driven bevel gear fixed to the drive member for rotation therewith about the drive axis; and
a drive bevel gear fixed to the drive end of the shaft for rotation therewith about the shaft axis, the bevel gears engaged with each other to transmit torque from the shaft to the drive member.

7. The multimode hand tool of claim 6 wherein:
the driven bevel gear and the drive member are a unitary component formed from a single piece of material; and
the drive bevel gear and the shaft are a unitary component formed from a single piece of material.

8. The multimode hand tool of claim 1 wherein the drive axis and the shaft axis are perpendicular to each other.

9. The multimode hand tool of claim 1 wherein:
the driven end of the shaft has a hexagonal shaped transverse cross-section; and
the shaft further comprises a cylindrical shaped portion extending from the driven end toward the drive end, the cylindrical shaped portion extending through the ratchet mechanism with the shaft housing in the first position.

10. The multimode hand tool of claim 1 wherein one of the handle and the shaft housing comprises a detent mechanism that is releasably engaged with a detent receiving relief on the other of the handle and the shaft housing in each of the first, second and third positions.

11. The multimode hand tool of claim 10 wherein the handle comprises:
the detent mechanism; and
at least one bearing surface mounting the shaft housing for rotation and translation relative to the handle.

12. A multimode hand tool for driving a threaded fastener component in at least two different modes, the hand tool comprising:
a drive head
a drive member mounted in the drive head for rotation about a drive axis, the drive member having a through opening centered on the drive axis and configured to engage with an exterior drive surface of at least one of a threaded nut and a nut driving socket;
a shaft housing extending from the drive head along a shaft axis, the shaft axis being non-parallel to the drive axis, the drive head fixed to the shaft housing;
a shaft mounted in the shaft housing for rotation about the shaft axis, the shaft extending along the shaft axis from a driven end of the shaft to a drive end of the shaft, the driven end having an exterior surface configured for selective engagement with a handheld power drive to transfer torque from the power drive to the shaft, the drive end operably connected to the drive member to transfer torque to the drive member;
a handle extending along the shaft axis from a first end adjacent the drive head to a second end adjacent the driven end of the shaft, the shaft housing mounted in the handle to translate along the shaft axis between first and second positions and the shaft fixed in the shaft housing for translation therewith between the first and second positions; and
a ratchet mechanism mounted in the hand tool to selectively transmit a torque between the handle and the shaft;
wherein:
   in the first position the driven end of the shaft extends outwardly from the second end of the handle for selective engagement with a handheld power drive to transfer torque from the handheld power drive to the drive member; and
   in the second position the handle and the shaft housing are engaged to prevent relative rotation therebetween and the driven end of the shaft is engaged with the ratchet mechanism to transfer torque from the handle to the drive member as the drive head is rotated about the drive axis.

13. The multimode hand tool of claim 12 wherein the ratchet is mounted in the drive head.

14. The multimode hand tool of claim 12 wherein the ratchet is mounted adjacent the second end of the handle.

15. The multimode hand tool of claim 12 wherein:
the shaft housing is mounted in the handle to translate along the shaft axis to a third position; and
in the third position the shaft is engaged with the ratchet mechanism to transfer torque from the handle to the drive member as the handle is rotated about the shaft axis relative to the shaft housing.

What is claimed is:

1. A multimode hand tool for driving a threaded fastener component in at least three different modes, the hand tool comprising:
a drive head
a drive member mounted in the drive head for rotation about a drive axis, the drive member having a through opening centered on the drive axis and configured to engage with an exterior drive surface of at least one of a threaded nut and a nut driving socket;
a shaft housing extending from the drive head along a shaft axis, the shaft axis being non-parallel to the drive axis, the drive head fixed to the shaft housing;
a shaft mounted in the shaft housing for rotation about the shaft axis, the shaft extending along the shaft axis from a driven end of the shaft to a drive end of the shaft, the driven end having an exterior surface configured for selective engagement with a handheld power drive to transfer torque from the power drive to the shaft, the drive end operably connected to the drive member to transfer torque to the drive member;
a handle extending along the shaft axis from a first end adjacent the drive head to a second end adjacent the driven end of the shaft, the shaft housing mounted in the handle to translate along the shaft axis between first, second and third positions and the shaft fixed in the shaft housing for translation therewith between the first, second and third positions; and
a ratchet mechanism mounted adjacent the second end of the handle and the driven end of the shaft to selectively transmit a torque between the handle and the shaft;
wherein:
in the first position the driven end of the shaft extends outwardly from the second end of the handle for selective engagement with a handheld power drive to transfer torque from the handheld power drive to the drive member,
in the second position the handle and the shaft housing are engaged to prevent relative rotation therebetween and the driven end of the shaft is engaged with the ratchet mechanism to transfer torque from the handle to the drive member as the drive head is rotated about the drive axis; and
in the third position the driven end of the shaft is engaged with the ratchet mechanism to transfer torque from the handle to the drive member as the handle is rotated about the shaft axis relative to the shaft housing.

2. The multimode hand tool of claim 1 wherein the ratchet mechanism comprises a ratchet housing fixed in the second end of the handle, a ratchet spline mounted in the ratchet housing for rotation about the shaft axis relative to the handle, and at least one pawl carried in the ratchet housing for transmitting a torque from the ratchet housing to the ratchet spline.

3. The multimode hand tool of claim 2 wherein the ratchet mechanism is configured to selectively transfer torque in first and second rotational directions, and wherein the ratchet mechanism further comprises a selector member mounted at the second end of the handle for rotation about the shaft axis relative to the handle between a first rotational position that enables the ratchet mechanism to transfer torque in the first rotational direction and a second rotational position that enables the ratchet mechanism to transfer torque in the second rotational direction.

4. The multimode hand tool of claim 2 wherein
the driven end of the shaft is engaged with the spline for rotation of the shaft therewith with the shaft housing in the second and third positions; and
the driven end of the shaft is disengaged from the spline and the shaft rotates relative to the spline with the shaft housing in the first position.

5. The multimode hand tool of claim 1 wherein the drive head and the shaft housing are a unitary component formed from a single piece of material.

6. The multimode hand tool of claim 1 further comprising:
a driven bevel gear fixed to the drive member for rotation therewith about the drive axis; and
a drive bevel gear fixed to the drive end of the shaft for rotation therewith about the shaft axis, the bevel gears engaged with each other to transmit torque from the shaft to the drive member.

7. The multimode hand tool of claim 6 wherein:
the driven bevel gear and the drive member are a unitary component formed from a single piece of material; and
the drive bevel gear and the shaft are a unitary component formed from a single piece of material.

8. The multimode hand tool of claim 1 wherein the drive axis and the shaft axis are perpendicular to each other.

9. The multimode hand tool of claim 1 wherein:
the driven end of the shaft has a hexagonal shaped transverse cross-section; and
the shaft further comprises a cylindrical shaped portion extending from the driven end toward the drive end, the cylindrical shaped portion extending through the ratchet mechanism with the shaft housing in the first position.

10. The multimode hand tool of claim 1 wherein one of the handle and the shaft housing comprises a detent mechanism that is releasably engaged with a detent receiving relief on the other of the handle and the shaft housing in each of the first, second and third positions.

11. The multimode hand tool of claim 10 wherein the handle comprises:
the detent mechanism; and
at least one bearing surface mounting the shaft housing for rotation and translation relative to the handle.

12. A multimode hand tool for driving a threaded fastener component in at least two different modes, the hand tool comprising:
a drive head
a drive member mounted in the drive head for rotation about a drive axis, the drive member having a through opening centered on the drive axis and configured to engage with an exterior drive surface of at least one of a threaded nut and a nut driving socket;
a shaft housing extending from the drive head along a shaft axis, the shaft axis being non-parallel to the drive axis, the drive head fixed to the shaft housing;
a shaft mounted in the shaft housing for rotation about the shaft axis, the shaft extending along the shaft axis from a driven end of the shaft to a drive end of the shaft, the driven end having an exterior surface configured for selective engagement with a handheld power drive to transfer torque from the power drive to the shaft, the drive end operably connected to the drive member to transfer torque to the drive member;
a handle extending along the shaft axis from a first end adjacent the drive head to a second end adjacent the driven end of the shaft, the shaft housing mounted in the handle to translate along the shaft axis between first and second positions and the shaft fixed in the shaft housing for translation therewith between the first and second positions; and
a ratchet mechanism mounted in the hand tool to selectively transmit a torque between the handle and the shaft;
wherein:
in the first position the driven end of the shaft extends outwardly from the second end of the handle for selective engagement with a handheld power drive to transfer torque from the handheld power drive to the drive member; and
in the second position the handle and the shaft housing are engaged to prevent relative rotation therebetween and the driven end of the shaft is engaged with the ratchet mechanism to transfer torque from the handle to the drive member as the drive head is rotated about the drive axis.

13. The multimode hand tool of claim 12 wherein the ratchet is mounted in the drive head.

14. The multimode hand tool of claim 12 wherein the ratchet is mounted adjacent the second end of the handle.

15. The multimode hand tool of claim 12 wherein:
the shaft housing is mounted in the handle to translate along the shaft axis to a third position; and
in the third position the shaft is engaged with the ratchet mechanism to transfer torque from the handle to the drive member as the handle is rotated about the shaft axis relative to the shaft housing.
